(19) United States
(12) Patent Application Publication
(10) Pub. No.: US 2004/0080704 A1
(43) Pub. Date: Apr. 29, 2004

(54) Apparatus of assembling display panels and method of manufacturing display device using assembling apparatus

(76) Inventors: Sung-Wook Jung, Seoul (KR); Sang-Jun Lee, Suwon-city (KR); Woo-Shik Lee, Seoul (KR); Yong-Joon Kwon, Seoul (KR)

Correspondence Address: CANTOR COLBURN, LLP, 55 GRIFFIN ROAD SOUTH, BLOOMFIELD, CT, 06002

(21) Appl. No.: 10/282,284

(22) Filed: Oct. 28, 2002

(51) Int. Cl. G02F 1/13

(52) U.S. Cl. 349/187

(57) ABSTRACT

The alignment films formed at the two display panels are alignment-treated, and spacers are formed on one of the two panels. A first sealant with a liquid crystal injection hole is formed on the one of the two panels, and a second sealant is formed around the first sealant in the shape of a closed curve. Thereafter, the two panels are delivered into a panels assembling chamber, and aligned to each other. The chamber is evacuated to be in a vacuum state, and the room surrounded by the two panels and the second sealant is sealed through closely adhering the two panels to each other under the vacuum atmosphere. Air is fed into the chamber while breaking the vacuum state of the chamber except for the room surrounded by the two panels and the sealant, thereby attaching the two panels to each other. The first and the second sealants are hardened to thereby complete a liquid crystal panel assembly. The first and the second sealants may be formed with a thermal hardening material or an ultraviolet ray hardening material. The first and the second sealants may be hardened using a thermal hardening unit or an ultraviolet ray illumination unit installed internal or external to the chamber.

### BACKGROUND OF THE INVENTION

(a) Field of the Invention

The present invention relates to an apparatus of assembling display panels and a method of manufacturing a display device using an assembling device and, more particularly, to a device for assembling two panels of a display device and a method of fabricating a display device using the same.

(b) Description of the Related Art

Generally, a display device, particularly a liquid crystal display (LCD), includes two panels with electrodes, and a liquid crystal material interposed between the two panels. The two panels are combined by a sealant printed near the periphery of the panels and encapsulating the liquid crystal material. The panels are supported by spacers spread between the two panels.

The LCD applies electric field to the liquid crystal material with dielectric anisotropy interposed between the two panels by way of the electrodes. Images are displayed by adjusting the strength of the electric field to control the amount of light passing through the panels. The two panels are combined by a sealant printed near the periphery of the panels and encapsulating the liquid crystal material.

According to a method of fabricating the LCD, alignment films for aligning the liquid crystal molecules of the liquid crystal material are coated on the two panels and are subject to alignment treatment. Spacers are spread on one of the panels, and a sealant is printed on the periphery of the panel such that the sealant has a liquid crystal injection hole. The two panels are aligned and attached to each other by hot press. A liquid crystal material is injected between the two panels through the injection hole and the injection hole is sealed, thereby forming a liquid crystal cell.

In the method of manufacturing the LCD, the gap between the two panels becomes a critical factor in determining driving characteristics of the display device as well as color representation characteristic thereof. Therefore, it has been important to develop a technique of maintaining the gap between the two panels to be uniform.

The gap between the two panels for the LCD is usually established to be 3-5 microns while permitting an allowable error of about ±0.2-0.3 microns. For thinner or smaller LCDs, the allowable error for the gap between the two panels is preferably controlled to be within ±0.1 microns.

However, the error of about several tens of microns is generated when using the hot press for closely contacting compression plates to the respective panels and adhering the two panels by applying heat and uniform pressure. In order to compensate for the error, sheets having cushions, which are attached to respective surfaces of the compression plates contacting the panels, are used for the hot press. However, the increased size of a main glass (called a mother glass), which is divided into a plurality of sub-glasses (referred to as “liquid crystal cells” hereinafter) in order to increase the productivity in a recent method of fabricating LCDs enlarges the error of the hot press. In addition, the cushion-including sheet does not fully compensate for the error.

### SUMMARY OF THE INVENTION

It is an object of the present invention to provide a device for assembling display panels capable of controlling the gap between the two panels in a precise manner, and a method of fabricating a display device using the same.

A device for assembling device panels and a method of fabricating a display device using the same uses an atmospheric difference to pressurize the panels, thereby completing a liquid crystal panel assembly.

Specifically, the display panels assembling device includes a chamber with an airtight space, and first and second stages mounted within the chamber to support the display panels while proceeding parallel to each other. A vacuum unit is installed external to the chamber to evacuate the chamber by way of pumping such that the chamber becomes to be in a vacuum state. An air supply unit is installed external to the chamber to feed air into the chamber.

The vacuum unit controls the vacuum degree of the chamber to be in the range of 10-10E⁻⁵ Torr. The air supply unit controls the air pressure of the chamber to be in the range of 360 Torr-2 ATM.

The air fed into the chamber by way of the air supply unit may be heated. The display panels assembling device may further include a thermal hardening unit for applying heat to the first and the second stages, or an ultraviolet ray hardening unit mounted within the chamber to illuminate ultraviolet ray.

The display panels assembling device may further include a first support mounted at the bottom inner wall of the chamber to support the first stage, a second support mounted at the top inner wall of the chamber to support the second stage, a position sensing unit mounted within the chamber to sense the position of the display panels, and an alignment stage installed external to the chamber to support the second stage within the chamber while carrying the panels.

In a method of fabricating a display device with two panels using the display panels assembling device, spacers are formed on one of the two panels. A sealant is formed on one of the two panels. The two panels are delivered into a panels assembling chamber. The chamber is evacuated such that the chamber becomes to be in a vacuum state. The room surrounded by the two panels and the sealant is sealed by closely adhering the two panels under the vacuum atmosphere. Air is fed into the chamber while pressurizing the panels by the air pressure to attach the panels.

In the step of forming the sealant, it is possible that a first sealant with a liquid crystal injection hole is formed, and a second sealant is formed around the first sealant in the shape of a closed curve.

The method may further include the steps of aligning the two panels, and hardening the sealant. The sealant is formed with a thermal hardening material or an ultraviolet ray hardening material, and hardened using a thermal hardening unit or an ultraviolet ray illumination unit installed internal or external to the chamber.

A support resin may be formed on one of the two panels external to the sealant to fix the position of the two panels. The vacuum degree of the chamber is established to be 10-10E⁻⁵ Torr in the vacuum state formation step. The pressure of the air fed into the chamber to attach the panels is controlled to be in the range of 360 Torr-2 ATM.

### BRIEF DESCRIPTION OF THE DRAWINGS

FIG. 1 is a plan view of a structure of a liquid crystal panel assembly fabricated by a method of fabricating a liquid crystal display using a device of assembling display panels according to an embodiment of the present invention;

FIG. 2 is a cross sectional view of the liquid crystal panel assembly shown in FIG. 1 taken along the line II-II′;

FIG. 3 is a schematic view illustrating the structure of a device of assembling display panels according to an embodiment of the present invention;

FIGS. 4A to 4D sequentially illustrate the steps of assembling display panels in a method of fabricating an LCD according to an embodiment of the present invention; and

FIG. 5 is a layout view illustrating the position of a support resin formed on a panel in a method of fabricating an LCD according to an embodiment of the present invention.

### DETAILED DESCRIPTION OF PREFERRED EMBODIMENTS

A device for assembling display panels and a method of fabricating a display device using the same according to preferred embodiments of this invention will be described with reference to the accompanying drawings for those skilled in the art to easily carry out.

The structure of a liquid crystal panel assembly fabricated by a method of fabricating a liquid crystal display using a device of assembling display panels according to an embodiment of the present invention will be first described.

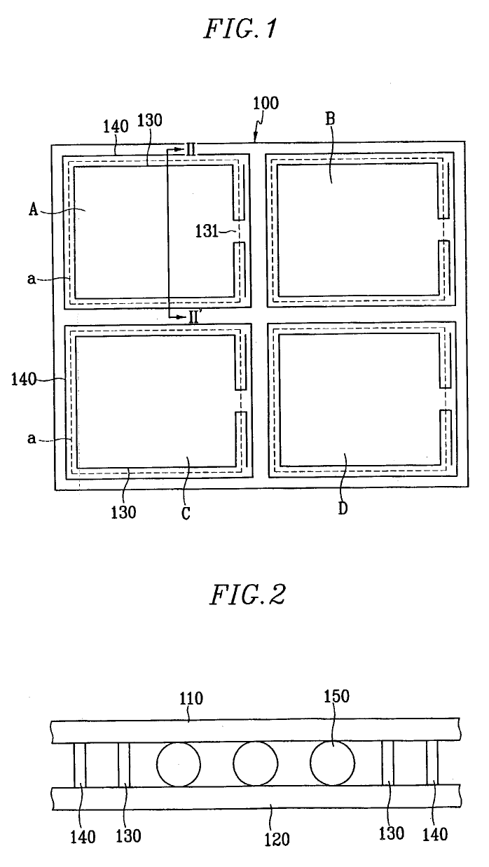

FIG. 1 is a plan view of a structure of a liquid crystal panel assembly fabricated by a method of fabricating a liquid crystal display using a device of assembling display panels according to an embodiment of the present invention, and FIG. 2 is a cross sectional view of the liquid crystal panel assembly shown in FIG. 1 taken along the line II-II′. The figures show the liquid crystal panel assembly after the completion of a panel assembling process.

As shown in FIGS. 1 and 2, a liquid crystal panel assembly 100 including one mother glass after the completion of a panel assembling process according to an embodiment of the present invention includes a plurality of liquid crystal cells. Four liquid crystal cell areas A, B, C and D are provided on an exemplary panel assembly 100 shown in FIG. 1, which includes two insulating panels 110 and 120 facing each other and spacers 150 disposed between the two panels 110 and 120 and supporting the panels 110 and 120 to maintaining a cell gap therebetween. A plurality of first sealants 130 provided at the respective liquid crystal cells are formed at the peripheries of the two panels 110 and 120 and have respective liquid crystal injection holes 131. Each first sealant 130 seals liquid crystal material (not shown) which will be injected during the liquid crystal injection process. A plurality of second sealants 140 surrounds the respective first sealant 130 and has shapes of closed loops. The room surrounded by the two panels 110 and 120 and the second sealant 140 will be in a vacuum state during a panel assembling process. The first or the second sealants 130 or 140 may contain spacers to support the two panels 110 and 120 in a parallel manner.

In a method of fabricating an LCD according to an embodiment of the present invention, the liquid crystal panel assembly 100 is separated into cells along the dotted lines “a” after the completion of the panel assembling process.

The panels 110 and 120 of the liquid crystal panel assembly 100 preferably include a plurality of signal wires for transmitting electrical signals such as scanning signals or picture signals and intersecting each other to define pixel areas. The panels 110 and 120 further includes a plurality of thin film transistors which are switching elements for controlling the picture signals and a plurality of pixel electrodes and a common electrode for generating electric fields to drive the liquid crystal molecules. In addition, the panels 110 and 120 include a plurality of red, green and blue color filters for displaying the picture images.

The structure of a device for assembling display panels used in a process of fabricating an LCD according to an embodiment of the present invention will be now described in detail.

FIG. 3 is a structural view of a display panel assembling device according to an embodiment of the present invention.

As shown in FIG. 3, a device for assembling display panels includes a chamber 230 with an airtight space, and first and second stages 210 and 220 mounted within the chamber 230 while facing each other to support the panels 110 and 120. The first and the second states 210 and 220 keep the positions of the two panels 110 and 120 parallel to each other. A vacuum pump 270 is provided external to the chamber 230 to make the internal space of the chamber 230 be in a vacuum state through pumping. An air supply unit 280 is also provided external to the chamber 230 to feed air into the chamber 230.

The vacuum pump 270 has a function of controlling the vacuum degree of the chamber 230 to be in the range of 10-10E⁻⁵ Torr during the panels assembling process. It is preferable that the air supply unit 280 has a function of controlling the air pressure of the chamber 230 to be in the range of 360 Torr-2 ATM during the panels assembling process.

Furthermore, the assembling device includes a first support 290 installed at the bottom inner wall of the chamber 230 to support the first stage 210, and a second support installed at the top inner wall of the chamber 230 to support the second stage 220. A position sensor 250 is mounted within the chamber 230 to sense the position of the panels 110 and 120 while aligning the two panels 110 and 120. An alignment stage 240 is provided external to the chamber 230 to support the second stage 220 within the chamber 230 via the alignment support 241. The alignment stage 240 controls the second stage 220 such that the position of the upper panel 120 can be controlled to align the two panels 110 and 120.

As shown in FIG. 3, the second support 260 has preferably a tube shape such that it can smoothly move the second stage 220 in various directions by way of the alignment stage 240 while not dissipating the vacuum or air pressure of the chamber 230.

A method of fabricating a LCD using a device for assembling display panels will be now described in detail.

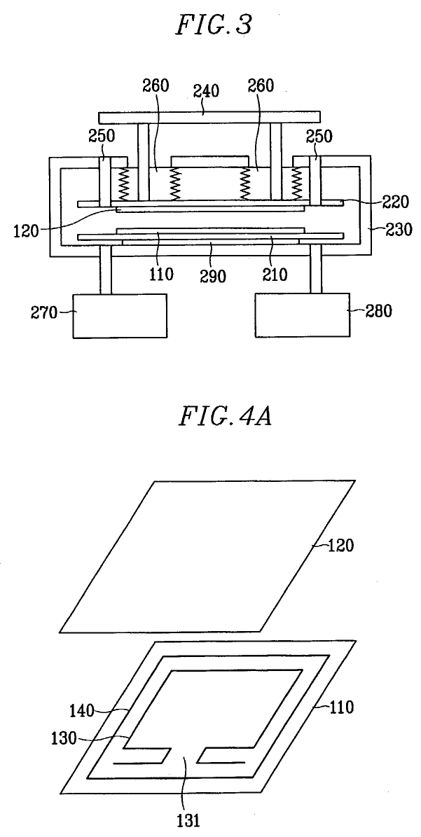

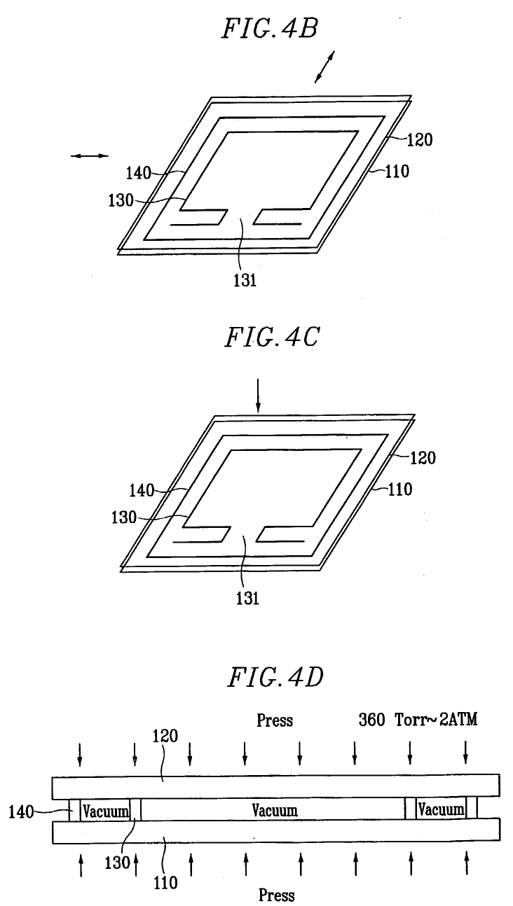

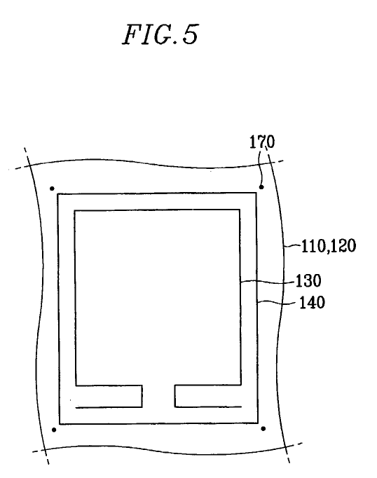

FIGS. 4A to 4D sequentially illustrate the steps of assembling panels in the fabrication of the LCD.

First, with the inventive method of fabricating the LCD, an alignment film is coated on the respective panels 110 and 120 (as shown in FIG. 1) to align the liquid crystal molecules of the liquid crystal material in a predetermined direction, and alignment-treated through rubbing or light illumination. Spacers 150 (as shown in FIG. 1) are spread onto one of the panels 110 and 120 to space the panels 110 and 210 from each other by a predetermined gap. A first sealant 130 (as shown in FIG. 1) with a liquid crystal injection hole 131 is printed around the panel 110, and a second sealant 140 (as shown in FIG. 1) is printed around the first sealant 130. The second sealant 140 is in the shape of a closed loop to make the room surrounded by the panels 110 and 120 and the second sealant 140 be in a vacuum state during the subsequent panels assembling process. The first and the second sealants 130 and 140 may contain a thermal hardening material or an ultraviolet ray hardening material.

Thereafter, as shown in FIG. 4A, the lower and the upper panels 110 and 120 are delivered into the chamber 230 (as shown in FIG. 3), and installed at the first and the second stages 210 and 220 (as shown in FIG. 3). The chamber 230 is evacuated using a vacuum pump 270 (as shown in FIG. 1) to be in a vacuum state. The vacuum degree in the chamber 23 is maintained to be 10-10E⁻⁵ Torr.

As shown in FIG. 4B, the alignment keys formed at the two panels 110 and 120 are sensed by way of a sensor 250 (as shown in FIG. 3) while maintaining the chamber 230 to be in a vacuum state. The upper panel 120 is brought in the horizontal and vertical arrow directions using an alignment stage 240 (as shown in FIG. 1), thereby aligning the two panels 110 and 120.

As shown in FIG. 4C, when the chamber 230 is kept to be in a vacuum state, the second stage 220 is brought toward the first stage 210 such that the upper panel 120 is closely adhered to the lower panel 110 while contacting the second sealant 140. In this way, the room surrounded by the two panels 110 and 120 and the second sealant 140 is sealed. The pressurization of the upper panel 120 while sealing the room surrounded by the two panels 110 and 120 and the second sealant 140 is not to form an inter-cell gap, but to make the upper panel 120 contact the lower panel 110 by the second sealant 140. Therefore, it is preferable that the pressurization of the upper panel 120 is made at 0.5 ATM or less.

As shown in FIG. 4D, air is fed into the chamber 230 by way of an air supply unit 280 (as shown in FIG. 3) to thereby break the vacuum state of the chamber 230. The air supply unit 280 is preferably controlled such that the inner pressure of the chamber 230 is kept to be in the range of 360 Torr-2 ATM. The air supply may be made after the second stage 220 is detached from the upper panel 120, or before the detachment. At this time, the room surrounded by the two panels 110 and 120 and the second sealant 140 is kept in a vacuum state, and the pressure in the region of the chamber 230 except for that room to be in the range of 360 Torr-2 ATM. Consequently, an atmospheric difference is made between the room surrounded by the panels 110 and 120 and the second sealant 140 and the inner region of the chamber 230 except for that room. For this reason, upon receipt of a pressure of 360 Torr-2 ATM from the outside, the two panels 110 and 120 are uniformly pressurized such that the gap between them reaches the desired dimension, thereby attaching the two panels.

Thereafter, as shown in FIG. 1, the first and the second sealants 130 and 140 are heat-treated or illuminated by an ultraviolet ray, and hardened. The two panels 110 and 120 are assembled to form a liquid crystal panel assembly 100.

In case both the first and the second sealants 130 and 140 contain a thermal hardening material, the two panels 110 and 120 may be attached to each other by delivering them to the outside of the chamber 230 and heating them at 50-200° C. using a separate thermal hardening unit such as an oven or a hot plate. Alternatively, a separate thermal hardening unit for attaching the panels 110 and 120 may be installed in the chamber 230.

Furthermore, in case both the first and the second sealants 130 and 140 contains a thermal hardening material, the air heated at 50-200° C. by an air supply unit 280 (as shown in FIG. 3) is fed into the chamber 230 to break the vacuum state of the chamber 230 except for the room surrounded by the two panels 110 and 120 and the second sealant 140. Consequently, the heated air fed into the chamber 230 makes the two panels 110 and 120 be attached to each other by the air pressure such that the gap between the panels 110 and 120 reaches the desired dimension. The first and the second sealants 130 and 140 are thermally hardened to complete a liquid crystal panel assembly 100 (as shown in FIG. 1). The air supply unit 280 may involve an air heater for feeding the heated air.

Furthermore, in case both the first and the second sealants 130 and 140 contain a thermal hardening material, heat is applied to the panels 110 and 120 through the first and the second stages 210 and 220. Consequently, the panels 110 and 120 are attached to each other by the air pressure such that the gap between them reaches the desired dimension. The first and the second sealants 130 and 140 are thermally hardened to complete a liquid crystal panel assembly 100 (as shown in FIG. 1). The inventive device of assembling display panels may involve a thermal hardening unit for applying heat to the first and the second stages 210 and 220.

Furthermore, in order to prevent the two panels 110 and 120 from being deviated from each other during the step of attaching the panels 110 and 120 by the air pressure while breaking the vacuum state of the chamber 230, as shown in FIG. 5, a support resin 170 including an ultraviolet ray hardening material may be separately provided formed at the external periphery of the second sealant 140. The support resin 170 is formed at one of the panels 110 and 120 before the panels 110 and 120 are delivered into the chamber 230. At this time, as described earlier, after the two panels 110 and 120 are aligned and fixed at their proper positions using the support resin 170, the room surrounded by the panels 110 and 120 and the second sealant 140 is sealed and attaches the panels 110 and 120. The inventive device of assembling display panels may further involve an ultraviolet ray illumination unit mounted in the chamber 230. When the two panels 110 and 120 are fixed through hardening the support resin 170 by ultraviolet ray, the two panels 110 and 120 are prevented from being misaligned from each other due to the deviation thereof during the step of attaching the panels 110 and 120 by the air pressure while breaking the vacuum state, delivering the liquid crystal panel assembly 100 from the inside of the chamber 230 to the outside thereof, or assembling the panels 110 and 120 by hardening the first sealant 130.

Furthermore, the second sealant 140 may be formed using an ultraviolet ray hardening material. At this time, as described above, after the two panels 110 and 120 are aligned and fixed at their proper positions while sealing the room surrounded by the panels 110 and 120 and the second sealant 140 through hardening the second sealant 140 by way of ultraviolet ray, the two panels 110 and 120 are attached to each other. The inventive device of assembling display panels may further involve an ultraviolet ray illumination unit mounted within the chamber 230. In this way, as described above, the two panels 110 and 120 can be prevented from being misaligned from each other due to the deviation thereof during the step of assembling the two panels 110 and 120. Meanwhile, after the liquid crystal panel assembly 100 is completed through assembling the two panels 110 and 120, the second sealant 140 may be hardened through illuminating ultraviolet ray thereto while hardening the first sealant 130 by way of heat.

Meanwhile, both the first and the second sealants 130 and 140 may include an ultraviolet ray hardening material. In this case, after the two panels 110 and 120 are aligned and fixed at their proper positions through partially hardening the second sealant 140 by the illumination of ultraviolet ray, the room surrounded by the panels 110 and 120 and the second sealant 140 is sealed while attaching the two panels 110 and 120 by the atmospheric difference. Finally, the first and the second sealants 130 and 140 are completely hardened through illuminating the ultraviolet ray again, and attached to each other to thereby complete a liquid crystal panel assembly 100 (as shown in FIG. 1). The inventive device of assembling display panels may further include an ultraviolet ray illumination unit mounted within the chamber 230. In this case, the two panels 110 and 120 can be prevented from being misaligned due to the deviation thereof during the step of assembling the two panels 110 and 120.

Accordingly, with the inventive device of assembling display panels, the display panels are assembled using an air pressure by way of the atmospheric difference, thereby precisely controlling the gap between the panels to bear an allowable error of 0.1 microns or less.

What is claimed is:

1. A device for assembling display panels, comprising:
a chamber having an airtight space;
first and second stages mounted in the chamber for supporting the display panels and facing each other;
an evacuator external to the chamber for evacuating the chamber by pumping; and
an air supply external to the chamber for feeding air into the chamber.

2. The device of claim 1 wherein the evacuator controls the vacuum degree of the chamber to be in a range of 10-10E⁻⁵ Torr.

3. The device of claim 1 wherein the air supply controls the air pressure of the chamber to be in a range of 360 Torr-2 ATM.

4. The device of claim 1 wherein the air fed into the chamber by the air supply is heated.

5. The device of claim 1 further comprising a thermal hardener for applying heat to the first and the second stages, or an ultraviolet ray hardener mounted in the chamber for illuminating ultraviolet ray.

6. The device of claim 1 further comprising:
a first support mounted at a bottom inner wall of the chamber for supporting the first stage;
a second support mounted at a top inner wall of the chamber for supporting the second stage;
a position sensor mounted in the chamber for sensing the position of the display panels; and
an alignment stage external to the chamber for supporting the second stage in the chamber and moving the positions of the panels.

7. A method of fabricating a display device, the method comprising:
providing spacers on one of two display panels;
forming a sealant on one of the two panels;
delivering the two panels into a panel assembling chamber;
evacuating the chamber;
sealing the room surrounded by the two panels and the sealant by closely contacting the two panels under vacuum atmosphere; and
attaching the two panels by feeding air into the chamber to pressurize the panels by the pressure of the air.

8. The method of claim 7 wherein the formation of the sealant comprises:
forming a first sealant with a liquid crystal injection hole; and
forming a second sealant around the first sealant in the shape of a closed loop.

9. The method of claim 7 further comprising:
aligning the two panels; and
hardening the sealant.

10. The method of claim 9 wherein the sealant includes a thermal hardening material or an ultraviolet ray hardening material, and the sealant is hardened using a thermal hardener or an ultraviolet ray illumination unit installed internal or external to the chamber.

11. The method of claim 7 further comprising:
forming a support resin on one of the two panels external to the sealant to fix the positions of the two panels.

12. The method of claim 7 wherein the vacuum degree of the chamber is established to be 10-10E⁻⁵ Torr during the evacuation of the chamber.

13. The method of claim 7 wherein the pressure of the air fed into the chamber during the attachment of the panels is controlled to be in a range of 360 Torr-2ATM.
